(19) United States
(12) Patent Application Publication
(10) Pub. No.: US 2026/0269499 A1
(43) Pub. Date: Sep. 10, 2026

(54) CABLE CONNECTOR

(71) Applicant: TE Connectivity Solutions GmbH, Schaffhausen (CH)

(72) Inventor: Michael Streckewald, Middletown, PA (US)

(21) Appl. No.: 19/069,856

(22) Filed: Mar. 4, 2025

(51) Int. Cl. H01R 12/75; H01R 13/6585

(52) U.S. Cl. CPC H01R 12/75; H01R 13/6585

(57) ABSTRACT

A cable connector includes a connector housing having housing walls forming a cavity and a cable assembly received in the cavity including a cable assembly support supporting cables in a cable array, contact assemblies terminated to ends of the cables, and ground shields associated with the contact assemblies. Each contact assembly includes a contact holder holding signal contacts with terminating ends and mating ends configured to interface with circuit conductors of the circuit board. The ground shields provide electrical shielding for the signal contacts and include ground beams configured to interface with ground pads of the circuit board. The cable assembly support includes a support plate supporting the contact assemblies and the ground shields and cable assembly actuators movable in the cavity in a mating direction generally perpendicular to the circuit board to move the contact assemblies and the ground shields in the mating direction relative to the connector housing.

### BACKGROUND OF THE INVENTION

The subject matter herein relates generally to cable connectors.

As electronic devices continue to advance, there is an increasing demand for high-speed data transmission between various components within a system. High-speed cable connectors play a critical role in ensuring reliable signal integrity and electrical performance when interfacing cables with circuit boards. These connectors are widely used in applications such as computing devices, telecommunications equipment, and high-frequency signal processing systems.

Despite their importance, conventional high-speed cable connectors face several challenges. One significant issue is the complexity of the connection interface between the cable and the circuit board. Many existing connectors require multiple interconnection points, increasing the risk of signal degradation, impedance mismatch, and electromagnetic interference. Additionally, the presence of multiple interfaces adds to the overall complexity of the assembly process, potentially leading to misalignment or improper mating of the connector components.

Another challenge associated with conventional high-speed cable connectors is the susceptibility of their electrical contacts to damage. Repeat mating an un-mating cycles, improper insertion, rough handling, poor storage conditions, or excessive mechanical stress can lead to deformation or wear of the connector contacts, which may result in poor electrical conductivity or complete failure of the connection. Furthermore, as high-speed data transmission necessitates precise impedance control and minimal signal loss, even minor contact damage can significantly degrade the overall performance of the system.

Accordingly, there is a need for an improved high-speed cable connector that reduces complexity, minimizes the number of interfaces between the cable and the circuit board, and enhances durability to prevent contact damage.

### BRIEF DESCRIPTION OF THE INVENTION

In one embodiment, a cable connector is provided and includes a connector housing that includes a cable end, and a mounting end configured to be mounted to a circuit board. The connector housing includes housing walls forming a cavity. The cable connector includes a cable assembly received in the cavity. The cable assembly includes a cable assembly support supporting cables in a cable array, contact assemblies terminated to ends of the cables, and ground shields associated with the contact assemblies. Each cable includes a pair of signal wires, a dielectric support, and a foil shield surrounding the signal wires. Each contact assembly includes a contact holder holding signal contacts. The signal contacts include terminating ends terminated to ends of the signal wires and mating ends opposite the terminating ends. The mating ends have separable mating interfaces configured to interface with circuit conductors of the circuit board. The ground shields provide electrical shielding for the signal contacts. The ground shields include ground beams that have separable mating interfaces configured to interface with ground pads of the circuit board. The cable assembly support includes a support plate. The contact assemblies and the ground shields are coupled to the support plate. The support plate includes cable assembly actuators movable in the cavity in a mating direction generally perpendicular to the circuit board to move the contact assemblies and the ground shields in the mating direction relative to the connector housing.

In another embodiment, a cable connector is provided and includes a mounting bracket that has bracket walls forming a receptacle. The mounting bracket includes a base configured to be mounted to a circuit board. The mounting bracket includes a mating window at the base exposed to the circuit board. The cable connector includes a connector housing pluggable into the receptacle in a loading direction generally parallel to the circuit board. The connector housing includes a cable end, and a mounting end positioned at the mating window and configured to be mounted to the circuit board. The connector housing includes housing walls forming a cavity. The cable connector includes a cable assembly received in the cavity. The cable assembly includes a cable assembly support supporting cables in a cable array, contact assemblies terminated to ends of the cables, and ground shields associated with the contact assemblies. Each cable includes a pair of signal wires and a foil shield surrounding the signal wires. Each contact assembly includes a contact holder holding signal contacts. The signal contacts include terminating ends terminated to ends of the signal wires and mating ends opposite the terminating ends. The mating ends have separable mating interfaces configured to interface with circuit conductors of the circuit board. The ground shields provide electrical shielding for the signal contacts. The ground shields include ground beams that have separable mating interfaces configured to interface with ground pads of the circuit board. The cable assembly support includes a support plate. The contact assemblies and the ground shields are coupled to the support plate. The support plate includes cable assembly actuators movable in the cavity in a mating direction generally perpendicular to the circuit board. The cable assembly actuators are configured to move the cable assembly relative to the connector housing in the mating direction when the connector housing and the cable assembly are loaded into the receptacle of the mounting bracket in the loading direction.

In a further embodiment, a cable assembly for a cable connector is provided. The cable assembly includes cables in a cable array. Each cable includes a pair of signal wires and a foil shield surrounding the signal wires. The cable assembly includes contact assemblies terminated to ends of the cables. Each contact assembly includes a contact holder holding signal contacts. The signal contacts include terminating ends terminated to ends of the signal wires and mating ends opposite the terminating ends. The mating ends have separable mating interfaces configured to interface with circuit conductors of a circuit board. The cable assembly includes ground shields associated with the contact assemblies. The ground shields provide electrical shielding for the signal contacts. The ground shields include ground beams have separable mating interfaces configured to interface with ground pads of the circuit board. The cable assembly includes a support plate. The contact assemblies being coupled to the support plate. The ground shields being coupled to the support plate. The support plate includes cable assembly actuators configured to be spring biased relative to a connector housing to move the contact assemblies and the ground shields in a mating direction relative to the connector housing.

### BRIEF DESCRIPTION OF THE DRAWINGS

FIG. 1 is a perspective view of a communication system in accordance with an exemplary embodiment.

FIG. 2 is a perspective view of a communication system in accordance with an exemplary embodiment partially mated.

FIG. 3 is an exploded view of a portion of the cable connector in accordance with an exemplary embodiment.

FIG. 4 is a perspective view of the cable assembly support in accordance with an exemplary embodiment.

FIG. 5 is a perspective view of the ground shield in accordance with an exemplary embodiment.

FIG. 6 illustrates the contact assembly poised for termination with the cable in accordance with an exemplary embodiment.

FIG. 7 is a perspective view of the connector housing in accordance with an exemplary embodiment.

FIG. 8 is a perspective view of a portion of the cable connector in accordance with an exemplary embodiment.

FIG. 9 is a bottom perspective view of a portion of the cable connector in accordance with an exemplary embodiment.

FIG. 10 is a perspective view of the mounting bracket mounted to the circuit board in accordance with an exemplary embodiment.

FIG. 11 is a partial sectional view of the cable connector showing the connector housing partially loaded into the mounting bracket in accordance with an exemplary embodiment.

FIG. 12 is a partial sectional view of the cable connector showing the connector housing fully loaded into the mounting bracket in accordance with an exemplary embodiment.

FIG. 13 is a cross-sectional view of the cable connector showing the connector housing partially loaded into the mounting bracket in accordance with an exemplary embodiment.

FIG. 14 is a cross-sectional view of the cable connector showing the connector housing fully loaded into the mounting bracket in accordance with an exemplary embodiment.

FIG. 15 is an enlarged cross-sectional view of a portion of the cable connector shown in FIG. 13 in accordance with an exemplary embodiment.

FIG. 16 is an enlarged cross-sectional view of a portion of the cable connector shown in FIG. 14 in accordance with an exemplary embodiment.

### DETAILED DESCRIPTION OF THE INVENTION

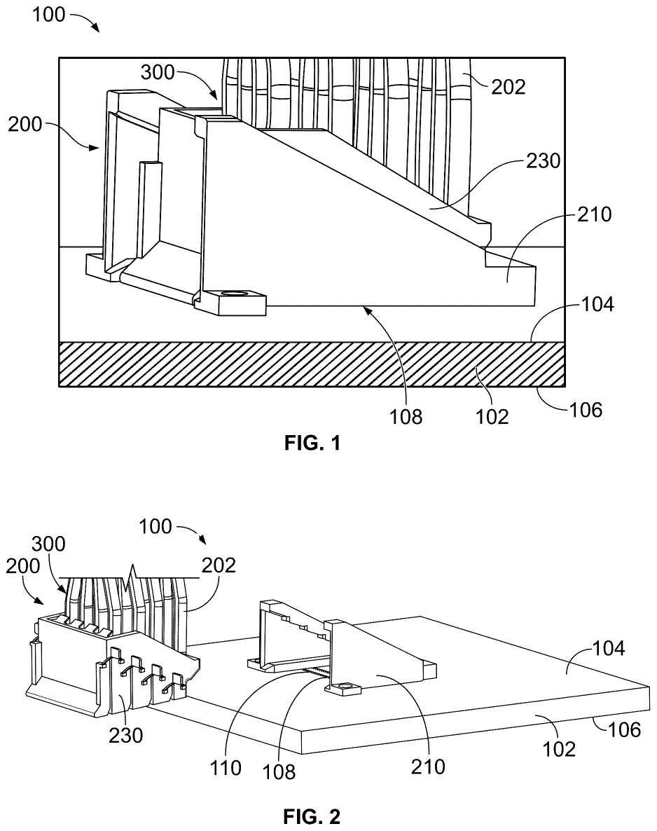

FIG. 1 is a perspective view of a communication system 100 in accordance with an exemplary embodiment. FIG. 2 is a perspective view of a communication system 100 in accordance with an exemplary embodiment partially mated. The communication system 100 includes a cable connector 200 provided at ends of cables 202. The cable connector 200 is configured to be electrically connected to a circuit board 102. In other various embodiments, the cable connector 200 may be mated with a mating electrical connector, such as a cable connector or card connector.

The circuit board 102 includes an upper surface 104 and a lower surface 106. The circuit board 102 includes a mating area 108 at the upper surface 104. The cable connector 200 is coupled to the circuit board 102 at the mating area 108. The circuit board 102 includes board contacts 110 at the mating area 108. The cable connector 200 electrically connected to the board contacts 110. The board contacts 110 may be circuits of the circuit board 102. The board contacts 110 may include pads, traces, vias, or other types of circuits of the circuit board 102. The board contacts 110 may include signal contacts, ground contacts, power contacts, and the like. In an exemplary embodiment, the circuit board 102 includes a ground plane defined by or coupled to the ground contacts.

In an exemplary embodiment, the cable connector 200 includes a mounting bracket 210 and a connector housing 230 holding one or more cable assemblies 300. The mounting bracket 210 is mounted to the circuit board 102. The connector housing 230 is coupled to the mounting bracket 210 to electrically connect to the circuit board 102. In an exemplary embodiment, the connector housing 230 is loaded into the mounting bracket 210 in a loading direction, which is generally parallel to the upper surface 104 of the circuit board 102. The cable assemblies 300 are coupled to the circuit board 102 when the connector housing 230 is loaded into the mounting bracket 210. In an exemplary embodiment, the cable assemblies 300 are movable relative to the connector housing 230 and configured to be actuated in a mating direction, different from the loading direction, to mate the cable assemblies 300 with the circuit board 102. In an exemplary embodiment, the mating direction is generally perpendicular to the loading direction. For example, the connector housing 230 may be loaded in a generally horizontal loading direction and the cable assemblies 300 may be mated in a generally vertical mating direction. In an exemplary embodiment, the cable assemblies 300 are automatically actuated in the mating direction as the connector housing 230 is loaded into the mounting bracket 210. For example, the cable assemblies 300 may interface with the mounting bracket 210 to actuate the cable assemblies 300 in the mating direction.

In an exemplary embodiment, while not engaged, the cable assemblies 300 are held in retracted positions such that the contacts at the mating interface are recessed in the connector housing 230. The connector housing 230 provides protection for the contacts from damage during transport and/or assembly. Having the cable assemblies 300 in the retracted position during loading of the connector housing 230 into the mounting bracket 210 prevents damage or wear to the board contacts 110, such as from wiping of the contacts across the board contacts 110, during loading of the connector housing 230 into the mounting bracket 210. The cable assemblies 300 may be moved to extended positions when the cable assemblies 300 are properly positioned at the mating area 108 of the circuit board 102. For example, the cable assemblies 300 may be moved to the extended positions when the cable assemblies 300 are aligned with the board contacts 110. The contacts of the cable assemblies 300 are mated to the board contacts 110 at separable mating interfaces.

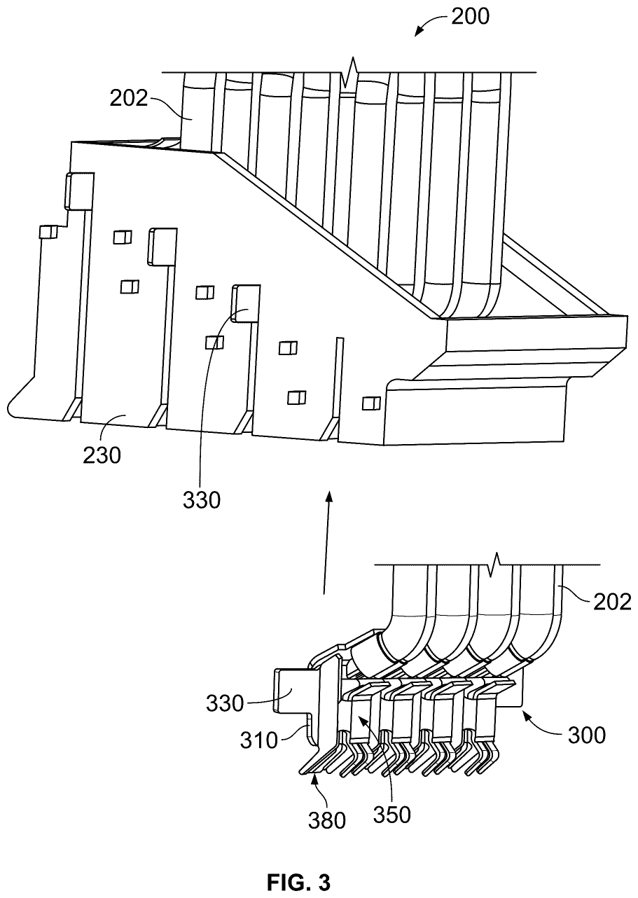

FIG. 3 is an exploded view of a portion of the cable connector 200 in accordance with an exemplary embodiment. FIG. 3 illustrates a plurality of the cable assemblies 300 showing one of the cable assemblies 300 poised for loading into the connector housing 230. In the illustrated embodiment, the cable connector 200 includes four of the cable assemblies 300. Greater or fewer cable assemblies 300 may be provided in alternative embodiments depending on the particular application and the number of signal channels required for the cable connector 200.

In the illustrated embodiment, the cable assemblies 300 are loaded into the connector housing 230 through a bottom of the connector housing 230. However, the cable assemblies 300 may be loaded into the connector housing 230 in other directions in alternative embodiments, such as through a top, a front, or a rear of the connector housing 230. The cables 202 extend from the connector housing 230, such as from the top of the connector housing 230. The cables 202 may extend in other directions in alternative embodiments, such as from the front and/or the rear of the connector housing 230.

Each cable assembly 300 includes a cable assembly support 310, contact assemblies 380, and ground shields 350 associated with the contact assemblies 380. The cable assembly support 310 supports a plurality of the cables 202 and the corresponding contact assemblies 380 and ground shields 350. The contact assemblies 380 are terminated to ends of the cables 202. The contact assemblies 380 are configured to be electrically connected to the circuit board 102, such as to signal contacts of the circuit board 102. The ground shields 350 provide electrical shielding for the contact assemblies 380 and/or the cables 202. In various embodiments, the cable assembly support 310 may additionally provide electrical shielding for the contact assemblies 380 and/or the cables 202. In an exemplary embodiment, the ground shields 350 and/or the cable assembly support 310 may be electrically connected to the cables 202. In an exemplary embodiment, the ground shields 350 and/or the cable assembly support 310 may be electrically connected to the circuit board 102, such as to ground contacts and/or a ground plane of the circuit board 102.

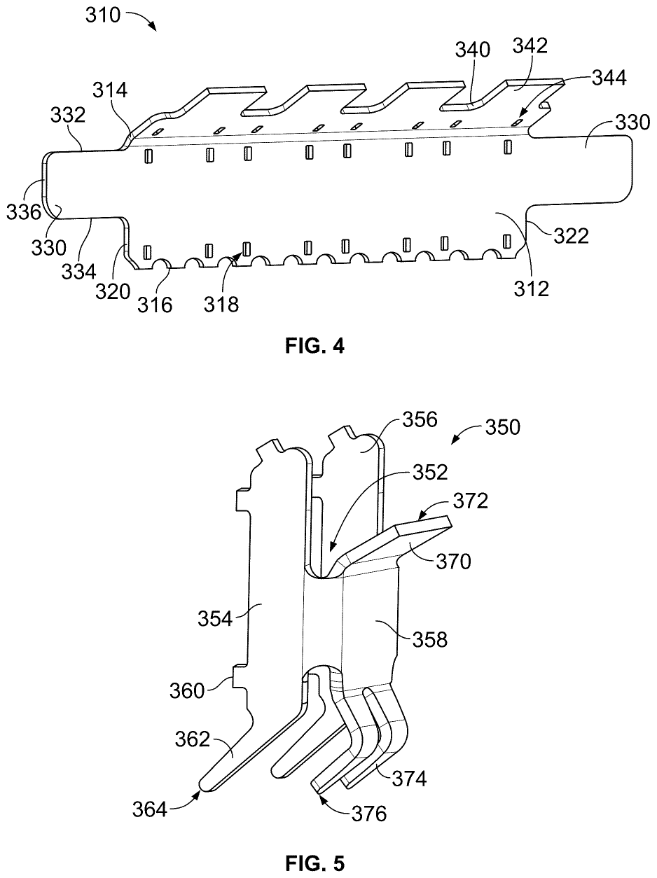

FIG. 4 is a perspective view of the cable assembly support 310 in accordance with an exemplary embodiment. In an exemplary embodiment, the cable assembly support 310 is manufactured from a conductive material, such as a metal material, such as stainless steel, aluminum, copper, or other metal material. The conductive material of the cable assembly support 310 may be used for electrical grounding and/or to provide electrical shielding. In an exemplary embodiment, the cable assembly support 310 is a stamped and formed part. For example, the cable assembly support 310 may be stamped from a metal sheet and bent into a predetermined shape.

The cable assembly support 310 includes a support plate 312. The support plate 312 is used to support the contact assemblies 380 and/or the ground shields 350 (shown in FIG. 3). In an exemplary embodiment, the support plate 312 is a flat, planar, plate-like element. The support plate 312 extends between a top 314 and a bottom 316. The support plate 312 includes a plurality of openings 318. The openings 318 may receive portions of the ground shields 350 and/or portions of the contact assemblies 380. In various embodiments, the support plate 312 may include ground beams (not shown) extending from the bottom 316 that are configured to electrically connect to the circuit board 102.

In an exemplary embodiment, the cable assembly support 310 includes cable assembly actuators 330 extending from opposite sides 320, 322 of the support plate 312. The cable assembly actuators 330 are used to actuate or move the cable assembly 300 during mating with the circuit board 102. In the illustrated embodiment, the cable assembly actuators 330 are ears or wings extending from the sides 320, 322 of the support plate 312. The cable assembly actuators 330 may be coplanar with the support plate 312. In an exemplary embodiment, the cable assembly actuators 330 include an upper edge 332, a lower edge 334, and a distal edge 336 between the upper and lower edges 332, 334. The cable assembly actuators 330 may be generally rectangular shaped. However, in alternative embodiments, the cable assembly actuators 330 may have different sizes and/or shapes and/or the cable assembly actuators 330 may extend in other directions from the support plate 312 or other parts of the cable assembly support 310. In various embodiments, the cable assembly actuators 330 may include deflectable portions (not shown), such as spring beams, bias springs, or other types of deflectable portions. For example, the spring beams may be stamped from the cable assembly actuators 330. The spring beams may be located along the lower edge 334 4 at other locations.

In an exemplary embodiment, the cable assembly support 310 includes a hood 340 extending from the top 314 of the support plate 312. The hood 340 is bent or angled relative to the support plate 312. For example, the hood 340 may be bent into a generally forward and upward direction relative to the support plate 312. The hood 340 may be angled at an angle of between 30° and 60°. For example, in the illustrated embodiment, the hood 340 is angled at approximately 45° relative to the support plate 312. The hood 340 is bent in the direction of the cables 202 (shown in FIG. 3). The hood 340 may be bent at the same angle as the cable exit direction to follow the path of the cables 202. The hood 340 may provide shielding for the cables 202. In various embodiments, the hood 340 may be electrically connected to the cables 202. For example, the hood 340 may include connecting portions 342 configured to be electrically connected to the cables 202. The connecting portions 342 may be soldered, crimped, or otherwise electrically connected to the cables 202. In an exemplary embodiment, the hood 340 includes openings 344 configured to receive portions of the ground shields 350 and/or the contact assemblies 380. The openings 344 may be aligned with the openings 318 of the support plate 312.

FIG. 5 is a perspective view of the ground shield 350 in accordance with an exemplary embodiment. In an exemplary embodiment, the ground shield 350 is manufactured from a conductive material, such as a metal material, such as stainless steel, aluminum, copper, or other metal material. The conductive material of the ground shield 350 may be used for electrical grounding and/or to provide electrical shielding. In an exemplary embodiment, the ground shield 350 is a stamped and formed part. For example, the ground shield 350 may be stamped from a metal sheet and bent into a predetermined shape. In the illustrated embodiment, the ground shield 350 is U-shaped or C-shaped to provide shielding on three sides of the corresponding contact assemblies 380. The ground shield 350 is configured to be coupled to the support plate 312 of the cable assembly support 310 (shown in FIG. 4) to provide shielding along the fourth side of the corresponding contact assemblies 380. The ground shield 350 may have other shapes in alternative embodiments, such as being box shaped to provide shielding on four sides of the corresponding contact assembly.

The ground shield 350 includes a plurality of shielding walls surrounding a shield cavity 352. For example, the ground shield 350 may include a first side wall 354, a second side wall 356, and an end wall 358 between the first and second side walls 354, 356. The walls 354, 356, 358 provide shielding on three sides of the shield cavity 352. For example, the rear of the shield cavity 352 may be open between the first and second side walls 354, 356. Such opening may be covered by the support plate 312 when the ground shield 350 is coupled to the cable assembly support 310.

In an exemplary embodiment, the side walls 354, 356 include mounting tabs 360 configured to mount the ground shield 350 to the support plate 312. For example, the mounting tabs 360 may fit in the openings 318, 344 in the cable assembly support 310. The mounting tabs 360 may be welded, soldered, press-fit, or otherwise secured to the cable assembly support 310.

In an exemplary embodiment, the side walls 354, 356 include ground beams 362 extending from the bottom portions of the side walls 354, 356. The ground beams 362 are configured to be electrically connected to the circuit board 102, such as to ground pads on the circuit board 102. In an exemplary embodiment, the ground beams 362 are deflectable. For example, the ground beams 362 may be deflected during mating with the circuit board 102. In an exemplary embodiment, the ground beams 362 include separable mating interfaces 364 at or near distal ends of the ground beams 362. The separable mating interfaces 364 are configured to be coupled to the ground pads of the circuit board 102. In the illustrated embodiment, the ground beams 362 are angled, such as rearwardly. The ground beams 362 are angled in the direction of loading and mating to encourage wiping along the ground pads of the circuit board 102 during mating. The ground beams 362 may be angled nonparallel relative to the mating direction and nonparallel relative to the loading direction.

The end wall 358 is located at the front of the ground shield 350. In an exemplary embodiment, the end wall 358 is integral with the side walls 354, 356, such as being stamped and formed with the side walls 354, 356. In the illustrated embodiment, the end wall 358 is shorter than the side walls 354, 356. A cable shroud 370 extend from the top of the end wall 358. The cable shroud 370 may provide shielding for the cable 202. In various embodiments, the cable shroud 370 may be electrically connected to the cable 202. For example, the cable shroud 370 may include a connecting portion 372 configured to be electrically connected to the cable 202. The connecting portion 372 may be soldered, crimped, or otherwise electrically connected to the cable 202.

In an exemplary embodiment, the end wall 358 includes one or more ground beams 374 extending from the bottom of the end wall 358. The ground beams 374 are configured to be electrically connected to the circuit board 102, such as to ground pads on the circuit board 102. In an exemplary embodiment, the ground beams 374 are deflectable. For example, the ground beams 374 may be deflected during mating with the circuit board 102. In an exemplary embodiment, the ground beams 374 include separable mating interfaces 376 at or near distal ends of the ground beams 374. The separable mating interfaces 376 are configured to be coupled to the ground pads of the circuit board 102. In the illustrated embodiment, the ground beams 374 are angled, such as rearwardly. The ground beams 374 are angled in the direction of loading and mating to encourage wiping along the ground pads of the circuit board 102 during mating. The ground beams 374 may be angled nonparallel relative to the mating direction and nonparallel relative to the loading direction.

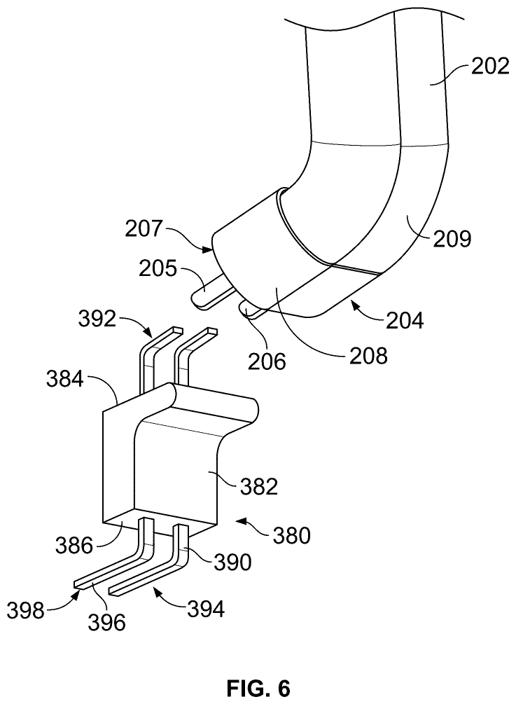

FIG. 6 illustrates the contact assemblies 380 poised for termination with the cable 202. An end 204 of the cable 202 is configured to be terminated to the contact assemblies 380. The cable 202 may be routed out of the cable connector to another component from the contact assemblies 380. In various embodiments, the end of the cable 202 may be bent or transitioned to a cable exit angle for termination to the contact assemblies 380 and for exiting the cable connector.

The cable 202 includes at least one signal conductor and a shield structure providing electrical shielding for the at least one signal conductor. In an exemplary embodiment, the cables 202 are twin-axial cables. For example, each cable 202 includes a first signal conductor 205 and a second signal conductor 206. The signal conductors 205, 206 carry differential signals. However, the cables 202 may include greater or fewer signal conductors in alternative embodiments, such as being a coaxial cable.

The cable 202 includes one or more insulators 207 surrounding the signal conductors 205, 206 and a foil shield 208 surrounding the insulators 207. The foil shield 208 provides circumferential shielding around the signal conductors 205, 206. The cable 202 includes a cable jacket 209 surrounding the foil shield 208. In various embodiments, the cable 202 includes one or more drain wires electrically connected to the foil shield 208.

In an exemplary embodiment, the cable jacket 209, the foil shield 208, and the insulators 207 may be removed (e.g., stripped) to expose portions of the signal conductors 205, 206 for termination to the contact assemblies 380. A portion of the foil shield 208 may be exposed and/or portions of the drain wires may be exposed for termination to the ground shield 350 and/or the cable assembly support 310. The exposed portions of the signal conductors 205, 206 are configured to be mechanically and electrically coupled (e.g., soldered) to corresponding signal contacts of the contact assemblies 380.

The contact assemblies 380 includes a contact holder 382 holding one or more signal contacts 390. In the illustrated embodiment, the contact assemblies 380 includes a pair of the signal contacts 390. Greater or fewer signal contacts 390 may be provided in alternative embodiments. The contact holder 382 is manufactured from a dielectric material. For example, the contact holder 382 may be manufactured from a plastic material. In various embodiments, the contact holder 382 is overmolded over the signal contacts 390. For example, the signal contacts 390 may be part of a stamped lead frame and the contact holder 382 is an overmolded body that is overmolded, in situ, over the signal contacts 390. The contact holder 382 extends between a top 384 and the bottom 386. In an exemplary embodiment, the signal contacts 390 extend from the top 384 and from the bottom 386.

The signal contacts 390 are stamped and formed contacts. Each signal contact 390 extends between a terminating end 392 and a mating end 394 opposite the terminating end 392. The terminating end 392 is configured to be terminated to the corresponding signal conductor 205, 206. In various embodiments, the terminating ends 392 includes a pad, such as a weld pad or solder pad, configured to be terminated to the corresponding signal conductor 205, 206, such as by welding or soldering. Other types of terminations may be used in alternative embodiments, such as a crimp connections, insulation displacement connections, or other type of termination. In an exemplary embodiment, the mating end 394 includes a signal beam 396 configured to be electrically connected to the circuit board 102, such as to a signal pads on the circuit board 102. In an exemplary embodiment, the signal beam 396 is deflectable. For example, the signal beam 396 may be deflected during mating with the circuit board 102. In an exemplary embodiment, the signal beam 396 includes a separable mating interface 398 at or near the distal end of the signal beam 396. The separable mating interfaces 398 is configured to be coupled to the signal pad of the circuit board 102. In the illustrated embodiment, the signal beam 396 is angled, such as rearwardly. The signal beam 396 is angled in the direction of loading and mating to encourage wiping along the signal pad of the circuit board 102 during mating. The signal beams 396 at the mating ends of the signal contacts 390 may be angled nonparallel relative to the mating direction and nonparallel relative to the loading direction.

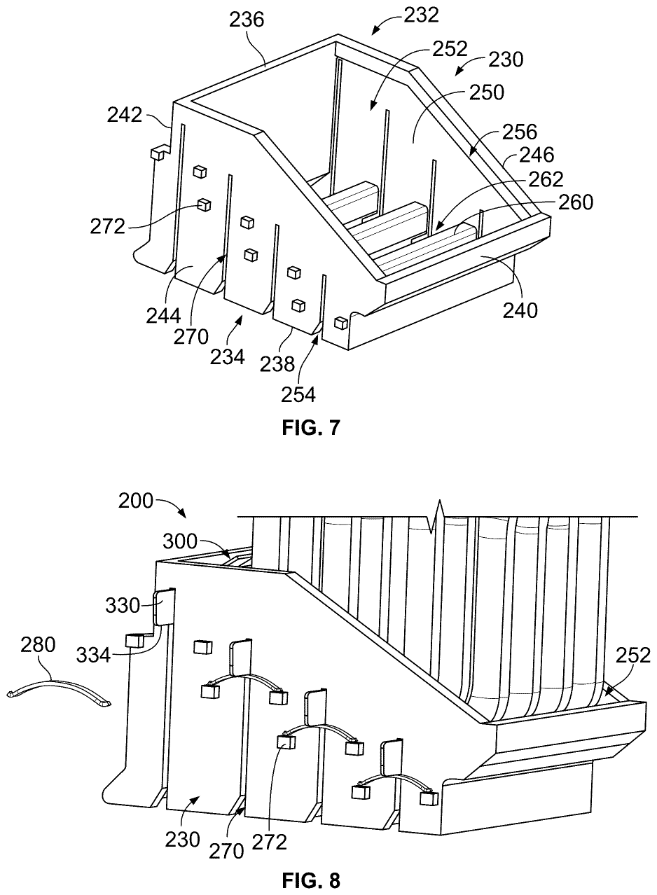

FIG. 7 is a perspective view of the connector housing 230 in accordance with an exemplary embodiment. In an exemplary embodiment, the connector housing 230 is manufactured from a dielectric material, such as a plastic material for example, the connector housing 230 may be a molded part. In alternative embodiments, the connector housing 230 may be manufactured from a conductive material to provide electrical shielding. For example, the connector housing 230 may be a stamped and formed part, a die cast part, a plated plastic part, and the like.

The connector housing 230 extends between a cable end 232 and a mounting end 234. The cables 202 are configured to extend from the cable end 232. The mounting end 234 is configured to be mounted to the circuit board 102. In an exemplary embodiment, the cable end 232 is located at a top 236 of the connector housing 230. In an exemplary embodiment, the mounting end 234 is located at a bottom 238 of the connector housing 230. However, the cable end 232 and/or the mounting end 234 may be located at a front 240 or a rear 242 of the connector housing 230 or at the sides 244, 246 of the connector housing 230.

The connector housing 230 includes housing walls 250 forming a cavity 252 configured to receive the cable assemblies 300. For example, the connector housing 230 may include a front wall, and/or a rear wall, and/or side walls, and/or a bottom wall, and/or a top wall. In an exemplary embodiment, the cavity 252 may receive the cable assemblies 300 through the bottom 238. However, in alternative embodiments, the cavity 252 may receive the cable assemblies 300 through the top 236. In the illustrated embodiment, the housing walls 250 have different heights. For example, the top of the connector housing 230 may be angled or ramped downward such that the front housing wall shorter than the rear housing wall. The connector housing 230 may have other shapes in alternative embodiments.

In an exemplary embodiment, the connector housing 230 includes a contact opening 254 at the mounting end 234. The contact opening 254 allows the contacts of the cable assemblies 300 to pass therethrough for connection to the circuit board 102. The contact opening 254 may be located at the bottom 238 of the connector housing 230. In an exemplary embodiment, the connector housing 230 includes a cable opening 256 at the cable end 232. The cable opening 256 allows the cables 202 of the cable assemblies 300 to pass therethrough. The cable opening 256 may be located at the top 236 of the connector housing 230.

In an exemplary embodiment, the connector housing 230 includes separating walls 260 dividing the cavity 252 into separate cable assembly chambers 262 that receive corresponding cable assemblies 300. In the illustrated embodiment, the separating walls 260 extend between the sides 244, 246 of the connector housing 230. The separating walls 260 may be located at or near the bottom 238 of the connector housing 230. The separating walls 260 may be used to guide or route the cables 202 within the cavity 252 of the connector housing 230.

In an exemplary embodiment, the connector housing 230 locating slots 270 in one or more of the housing walls 250. For example, the locating slots 270 may be provided in the housing walls 250 at the opposite sides 244, 246. The locating slots 270 are configured to receive portions of the cable assemblies 300. For example, the locating slots 270 may receive the cable assembly actuators 330 (shown in FIG. 4). The locating slots 270 are configured to guide the cable assembly actuators 330 in the mating direction relative to the connector housing 230. For example, the locating slots 270 may control movement of the cable assembly actuators 330 in a vertical direction (for example, prevent front to rear movement and/or side-to-side movement). The locating slots 270 extending the mating direction. For example, the locating slots 270 may extend vertically between the top 236 and the bottom 238. In the illustrated embodiment, the locating slots 270 are open at the bottom 238 to receive the cable assemblies 300 from below the connector housing 230. In alternative embodiments, the locating slots 270 may be open at the top 236 to receive the cable assemblies 300 from above the connector housing 230. In such embodiments, a cover may be coupled to the top 236 of the connector housing 230 to retain the cable assemblies 300 in the connector housing 230. In the illustrated embodiment, the locating slots 270 have different heights. For example, the locating slot 270 closest to the front 240 of the connector housing 230 is the shortest and the locating slot 270 closest to the rear 242 of the connector housing 230 is the tallest. Other arrangements are possible in alternative embodiments.

In an exemplary embodiment, the connector housing 230 includes support tabs 272 extending from one or more of the housing walls 250. For example, the support tabs 272 may extend from the housing walls 250 at the sides 244, 246. The support tabs 272 protruding from the exterior surfaces of the side walls. In an exemplary embodiment, the support tabs 272 are used to support biasing elements configured to interface with the cable assembly actuators 330 of the cable assemblies 300. The support tabs 272 may be located proximate to the locating slots 270. For example, the support tabs 272 may be located on opposite sides of the locating slots 270. Other locations are possible in alternative embodiments.

FIG. 8 is a perspective view of a portion of the cable connector 200 in accordance with an exemplary embodiment. FIG. 8 shows the cable assemblies 300 located in the cavity 252 of the connector housing 230. The cable assembly actuators 330 of the cable assemblies 300 are received in the corresponding locating slots 270. The cable assembly actuators 330 are movable within the locating slots 270 to move the cable assemblies 300 relative to the connector housing 230.

In an exemplary embodiment, the cable connector 200 includes biasing springs 280 coupled between the connector housing 230 and the cable assembly actuators 330. For example, the biasing springs 280 may be coupled to the support tabs 272. The biasing springs 280 are configured to engage the lower edges 334 of the cable assembly actuators 330. The biasing springs 280 are compressible to allow movement of the cable assemblies 300 in the mating direction (for example, downward). In an exemplary embodiment, the biasing springs 280 are the springs. Other types of biasing elements may be used in alternative embodiments, such as coil springs, torsion springs, contacts springs, concave springs, conical springs, banana springs, and the like. The biasing springs 280 may be metal springs, such as stamped and formed springs, coil springs, and the like. However, the biasing springs 280 may be manufactured from other materials, such as elastomeric springs. While the biasing springs 280 are shown as being located at the exterior of the connector housing 230. The biasing springs 280 may be located within the interior of the cavity 252 in alternative embodiments. In the illustrated embodiment, the biasing springs 280 are shown as separate and discrete components from the cable assembly actuators 330 and the connector housing 230. However, the biasing springs 280 may be integral with the cable assembly actuators 330 or the connector housing 230 in alternative embodiments. For example, the biasing springs 280 may be stamped from the cable assembly actuators 330 or the support plate 312 in alternative embodiments.

In an exemplary embodiment, the biasing springs 280 bias the cable assemblies 300 in an upward direction. The cable assembly actuators 330 are configured to be pressed downward, such as when interfacing the mounting bracket 210, to actuate the cable assemblies 300 in the mating direction from a retracted position to an extended position. The spring force of the biasing springs 280 may be overcome by the downward pressure on the cable assembly actuators 330 to move the cable assemblies 300 in the mating direction.

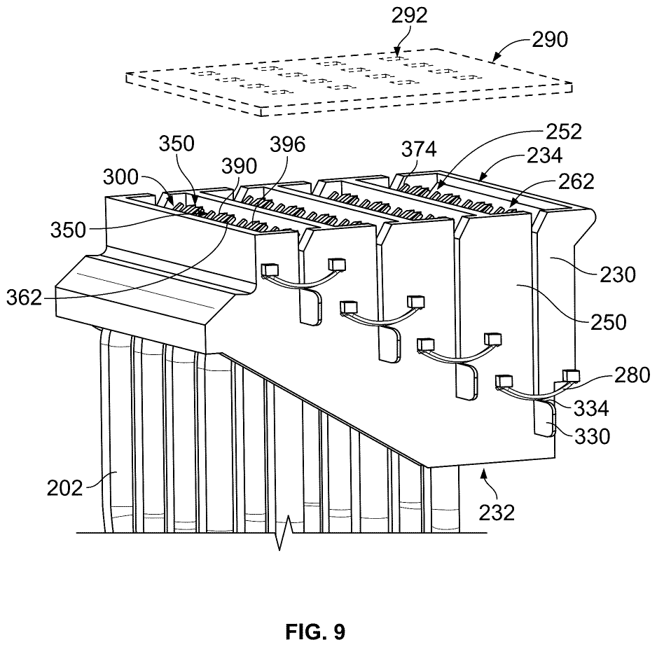

FIG. 9 is a bottom perspective view of a portion of the cable connector 200 in accordance with an exemplary embodiment. FIG. 9 shows the cable assemblies 300 relative to the connector housing 230. The cable assemblies 300 are received in the corresponding cable assembly chambers 262. The cables 202 extend from the cable end 232 of the connector housing 230. The contact assemblies 380 and the ground shields 350 are arranged at the mounting end 234 of the connector housing 230. In an exemplary embodiment, the cable assemblies 300 are held in retracted positions such that the signal contacts 390, at the mating interface, are recessed in the connector housing 230. For example, the biasing springs 280 engage the lower edges 334 of the cable assembly actuators 330 to bias the cable assemblies 300 in an upward direction such that the mating ends of the signal beams 396 and the mating ends of the ground beams 362, 374 are sub-flush (for example, recessed) relative to the mounting end 234 of the connector housing 230. With the cable assemblies 300 recessed, the connector housing 230 provides protection for the ends of the signal beams 396 and the ground beams 362, 374 from damage during transport and/or assembly. In extended positions after moving in the mating direction, the mating ends of the signal contacts 390 and the ground beams 362, 374 may protrude beyond the bottom of the connector housing 230 for mating with the circuit board 102.

In various embodiments, a contact organizer 290 (shown in phantom) may be received in the cavity 252 at the mounting end 232. The contact organizer 290 may form part of the connector housing 230. The contact organizer 290 may be coupled to one or more of the housing walls 250 of the connector housing 230. In other various embodiments, the contact organizer 290 may be integral with the housing walls 250 of the connector housing. For example, the contact organizer 290 may be co-molded with the housing walls 250. The contact organizer 290 includes openings 292. The openings 292 receive the mating ends of the signal contacts 390 and/or the mating ends of the ground beams 362, 374. Each opening may receive a single mating end or the openings 292 may be sized to receive multiple beams, such as the pair of the signal contacts 390 and/or one or more of the corresponding ground beams 362, 374. The cable assembly 300 are movable relative to the contact organizer 290. For example, the signal contacts 390 and the ground shields 350 may move relative to the contact organizer 290 to move the ends of the beams into and out of the openings 292 when the cable assembly 300 is moved in the mating direction. In the retracted positions, the mating ends of the signal contacts 390 and the ground beams 362, 374 are located sub-flush with the contact organizer 290. In extended positions, the mating ends of the signal contacts 390 and the ground beams 362, 374 may protrude beyond the bottom of the contact organizer 290 for mating with the circuit board 102.

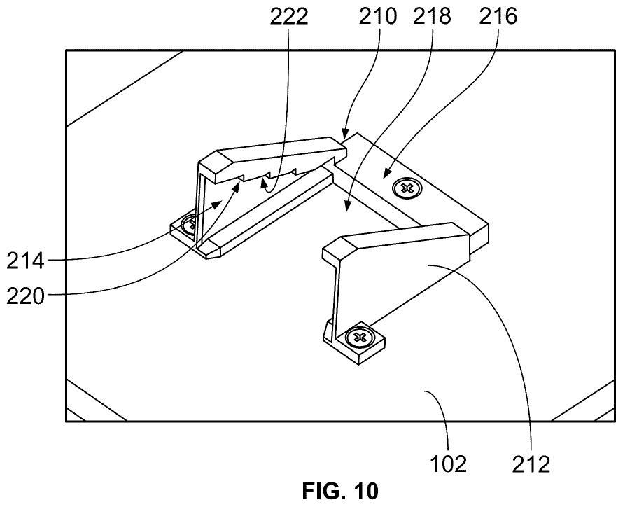

FIG. 10 is a perspective view of the mounting bracket 210 mounted to the circuit board 102. The mounting bracket 210 is fixed to the circuit board 102 to position the connector housing 230 and the cable assemblies 300 for mating with the circuit board 102. The mounting bracket 210 may be manufactured from a plastic material. For example, the mounting bracket 210 may be a molded part. In other various embodiments, the mounting bracket 210 may be manufactured from a metal material, such as being a die cast part.

The mounting bracket 210 includes bracket walls 212 forming a receptacle 214. The mounting bracket 210 includes a base 216 configured be mounted to the circuit board 102. For example, the base 216 may be secured to the circuit board 102 using fasteners, solder tabs, clips, latches, or other securing features. In an exemplary embodiment, the mounting bracket 210 includes a mating window 218 at the base 216 exposed to the circuit board 102. The connector housing 230 and/or the cable assemblies 300 may pass through the mating window 218 to interface with the circuit board 102. In an exemplary embodiment, the rear of the receptacle 214 is open and the connector housing 230 is configured to be plugged into the receptacle 214 through the opening at the rear. For example, the connector housing 230 may be plugged into the receptacle 214 in the loading direction through the rear parallel to the circuit board 102.

In an exemplary embodiment, the bracket walls 212 include ramps 220. The ramps 220 are configured to interface with the cable assemblies 300, such as the cable assembly actuators 330, when the connector housing 230 and the cable assemblies 300 are plugged into the receptacle 214. The ramps 220 are used to actuate the cable assemblies 300 in the mating direction. For example, the cable assembly actuators 330 are configured to interface with the ramps 220 to press the cable assemblies 300 in the downward mating direction toward the circuit board 102. In the illustrated embodiment, the ramps 220 includes steps 222. Each step 222 is configured to interface with the corresponding cable assembly actuators 330. Other types of actuating features may be used in alternative embodiments to interface with the cable assemblies 300 and drive the cable assembly 300 in the mating direction.

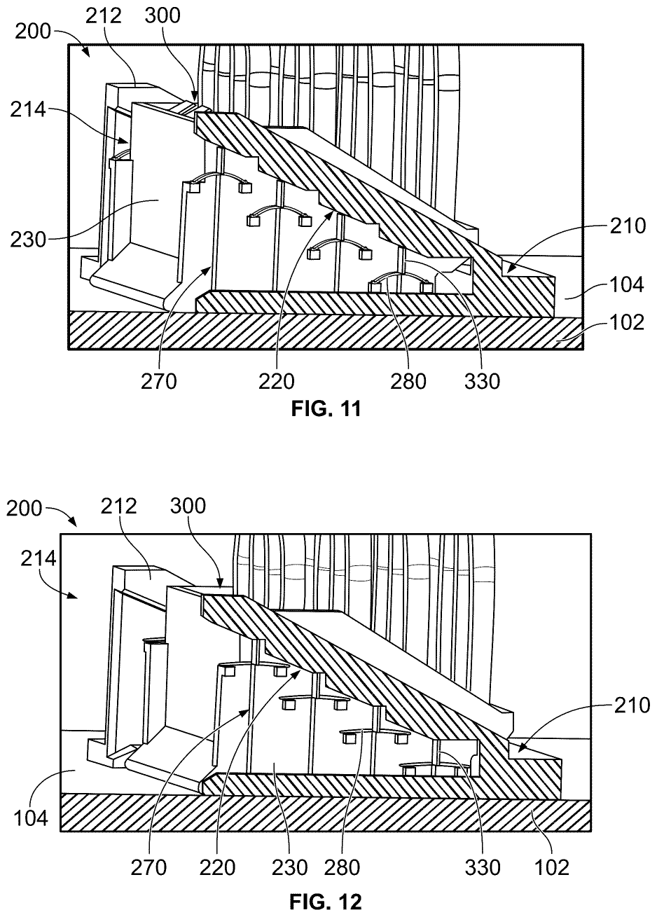

FIG. 11 is a partial sectional view of the cable connector 200 showing the connector housing 230 partially loaded into the mounting bracket 210. FIG. 12 is a partial sectional view of the cable connector 200 showing the connector housing 230 fully loaded into the mounting bracket 210.

During assembly, the connector housing 230 is loaded into the receptacle 214 through the opening at the rear of the mounting bracket 210. The connector housing 230 is slid in a forward loading direction. The connector housing 230 is positioned between the bracket walls 212 as the connector housing 230 slides forward in the loading direction. The connector housing 230 may slide along the upper surface 104 of the circuit board 102. During loading, the cable assemblies 300 are held in the upward, retracted positions such that the signal contacts 390 are recessed into the interior of the connector housing 230 and thus do not slide along the upper surface 104 of the circuit board 102. As the connector housing 230 is advanced into the receptacle 214, the cable assemblies 300 interface with the ramps 220 of the mounting bracket 210. As the connector housing 230 and the cable assemblies 300 are advanced in the forward loading direction, the ramps 220 are used to drive the cable assembly actuators 330 in the downward direction causing the cable assemblies 300 to move in the downward, mating direction. The cable assembly actuators 330 are received in the locating slots 270 and are movable in the locating slots 270 in the mating direction generally perpendicular to the circuit board 102. The biasing springs 280 are compressed as the cable assembly actuators 330 are pressed downward by the ramps 220. The downward movement of the cable assemblies 300 causes the signal contacts 390 and the ground shields 350 to extend from the connector housing 230 and mate directly with the circuit board 102.

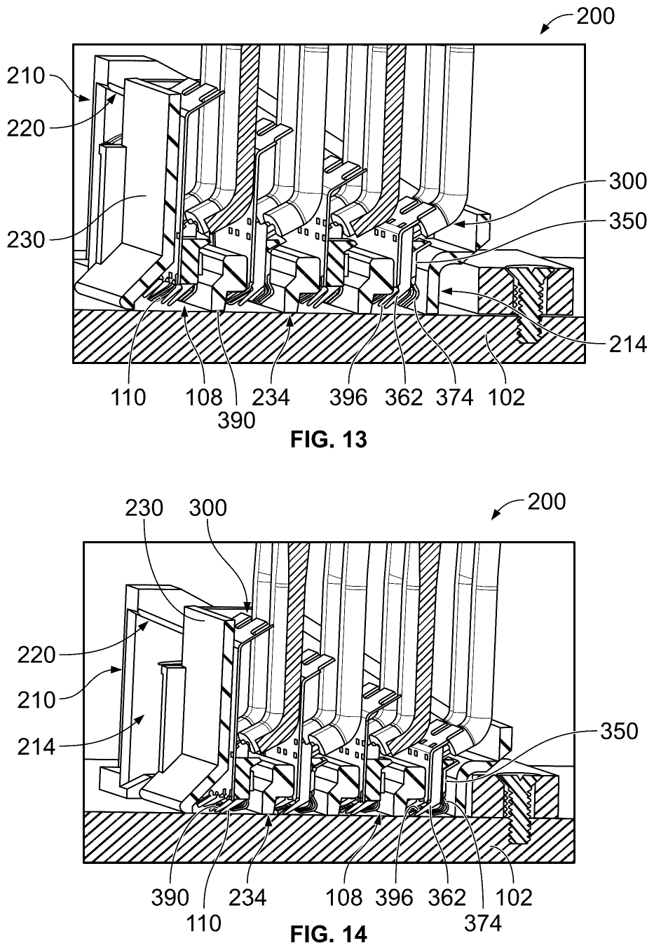

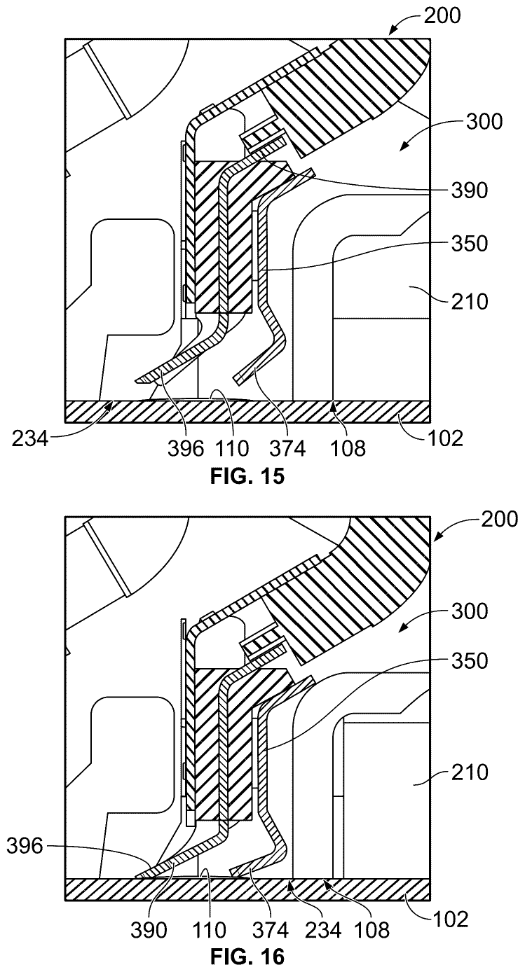

FIG. 13 is a cross-sectional view of the cable connector 200 showing the connector housing 230 partially loaded into the mounting bracket 210. FIG. 14 is a cross-sectional view of the cable connector 200 showing the connector housing 230 fully loaded into the mounting bracket 210. FIG. 15 is an enlarged cross-sectional view of a portion of the cable connector 200 shown in FIG. 13. FIG. 16 is an enlarged cross-sectional view of a portion of the cable connector 200 shown in FIG. 14.

During assembly, the connector housing 230 is loaded into the receptacle 214 through the opening at the rear of the mounting bracket 210. The connector housing 230 is slid in a forward loading direction. The cable assemblies 300 are initially held in the upward, retracted positions (FIGS. 13 and 15) such that the mating ends of the signal contacts 390 and the mating ends of the ground beams 362, 374 are sub-flush (for example, recessed) relative to the mounting end 234 of the connector housing 230. With the cable assemblies 300 recessed, the connector housing 230 provides protection for the ends of the signal beams 396 and the ground beams 362, 374 from damage during transport and/or assembly. Having the cable assemblies 300 in the retracted position during loading of the connector housing 230 into the mounting bracket 210 prevents damage or wear to the board contacts 110, such as from wiping of the signal beams 396 and the ground beams 362, 374 across the board contacts 110, during loading of the connector housing 230 into the mounting bracket 210.

During assembly, as the connector housing 230 is advanced into the receptacle 214, the cable assemblies 300 interface with the ramps 220 of the mounting bracket 210 and the ramps 220 drive the cable assembly actuators 330 in the downward direction causing the cable assemblies 300 to move in the downward, mating direction (FIGS. 14 and 16). The cable assemblies 300 are moved in the mating direction perpendicular to the loading direction as the connector housing 230 is loaded into the receptacle 214 in the loading direction. In the illustrated embodiment, the loading direction is a horizontal loading direction and the mating direction is a vertical mating direction. The downward movement of the cable assemblies 300 causes the signal contacts 390 and the ground shields 350 to extend from the connector housing 230 and mate directly with the circuit board 102. The cable assemblies 300 are moved to extended positions when the cable assemblies 300 are properly positioned at the mating area 108 of the circuit board 102. For example, the cable assemblies 300 are moved to the extended positions when the cable assemblies 300 are aligned with the corresponding board contacts 110. In the extended positions after moving in the mating direction, the mating ends of the signal contacts 390 and the ground beams 362, 374 may protrude beyond the bottom of the connector housing 230 for mating with the circuit board 102. The signal beams 396 and the ground beams 362, 374 are angled rearwardly in the direction of loading and mating to encourage wiping along the signal pads of the circuit board 102 during mating.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A cable connector comprising:
a connector housing including a cable end and a mounting end configured to be mounted to a circuit board, the connector housing including housing walls forming a cavity;
a cable assembly received in the cavity, the cable assembly including a cable assembly support supporting cables in a cable array, contact assemblies terminated to ends of the cables, and ground shields associated with the contact assemblies,
each cable including a pair of signal wires and a foil shield surrounding the signal wires;
each contact assembly including a contact holder holding signal contacts, the signal contacts including terminating ends terminated to ends of the signal wires and mating ends opposite the terminating ends, the mating ends having separable mating interfaces configured to interface with circuit conductors of the circuit board;
the ground shields provide electrical shielding for the signal contacts, the ground shields including ground beams having separable mating interfaces configured to interface with ground pads of the circuit board; and
the cable assembly support including a support plate, wherein the contact assemblies and the ground shields are coupled to the support plate, the support plate including cable assembly actuators movable in the cavity in a mating direction generally perpendicular to the circuit board to move the contact assemblies and the ground shields in the mating direction relative to the connector housing.

2. The cable connector of claim 1, wherein the cable assembly is moved in the mating direction perpendicular to a loading direction as the connector housing is loaded in the loading direction.

3. The cable connector of claim 2, wherein the loading direction is a horizontal loading direction and the mating direction is a vertical mating direction.

4. The cable connector of claim 1, wherein the mating ends of the signal contacts and mating ends of the ground beams are sub-flush to the mounting end of the connector housing prior to actuation of the cable assembly, the mating ends of the signal contacts and the mating ends of the ground beams protruding from the mounting end of the connector housing to interface with the circuit board when the cable assembly is actuated.

5. The cable connector of claim 1, wherein the housing walls include locating slots extending generally perpendicular to the circuit board, the cable assembly actuators received in the locating slots and movable in the locating slots in the mating direction generally perpendicular to the circuit board.

6. The cable connector of claim 5, wherein the locating slots are open at the mounting end of the connector housing, the cable assemblies being loaded into the cavity through the mounting end, the cable assembly actuators being received in the locating slots and protruding from an exterior of the connector housing.

7. The cable connector of claim 1, wherein the cable assembly actuators are spring biased relative to the connector housing to move the contact assemblies and the ground shields opposite the mating direction.

8. The cable connector of claim 7, wherein further comprising biasing springs coupled between the connector housing and the cable assembly actuators, the biasing springs being compressible as the cable assemblies moved in the mating direction.

9. The cable connector of claim 8, wherein the biasing springs are integral with the support plate.

10. The cable connector of claim 1, wherein the mating ends of the signal contacts are angled nonparallel relative to the mating direction and the loading direction.

11. The cable connector of claim 1, wherein the connector housing includes a contact organizer at the mounting end, the contact organizer including openings receiving the mating ends of the signal contacts, the signal contacts being movable relative to the contact organizer when the cable assembly is moved in the mating direction.

12. The cable connector of claim 1, wherein the cable assembly is one of a plurality of cable assemblies received in the cavity, the cable assemblies being independently movable relative to the connector housing.

13. A cable connector comprising:
a mounting bracket having bracket walls forming a receptacle, the mounting bracket including a base configured to be mounted to a circuit board, the mounting bracket including a mating window at the base exposed to the circuit board;
a connector housing pluggable into the receptacle in a loading direction generally parallel to the circuit board, the connector housing including a cable end and a mounting end positioned at the mating window and configured to be mounted to the circuit board, the connector housing including housing walls forming a cavity;
a cable assembly received in the cavity, the cable assembly including a cable assembly support supporting cables in a cable array, contact assemblies terminated to ends of the cables, and ground shields associated with the contact assemblies,
each cable including a pair of signal wires and a foil shield surrounding the signal wires;
each contact assembly including a contact holder holding signal contacts, the signal contacts including terminating ends terminated to ends of the signal wires and mating ends opposite the terminating ends, the mating ends having separable mating interfaces configured to interface with circuit conductors of the circuit board;
the ground shields provide electrical shielding for the signal contacts, the ground shields including ground beams having separable mating interfaces configured to interface with ground pads of the circuit board; and
the cable assembly support including a support plate, wherein the contact assemblies and the ground shields are coupled to the support plate, the support plate including cable assembly actuators movable in the cavity in a mating direction generally perpendicular to the circuit board;
wherein the cable assembly actuators are configured to move the cable assembly relative to the connector housing in the mating direction when the connector housing and the cable assembly are loaded into the receptacle of the mounting bracket in the loading direction.

14. The cable connector of claim 13, wherein the mounting bracket includes a loading ramp, the cable assembly actuators interfacing with the loading ramp to actuate the cable assembly in the mating direction.

15. The cable connector of claim 13, wherein the mating ends of the signal contacts and mating ends of the ground beams are sub-flush to the mounting end of the connector housing prior to actuation of the cable assembly, the mating ends of the signal contacts and the mating ends of the ground beams protruding from the mounting end of the connector housing to interface with the circuit board when the cable assembly is actuated.

16. The cable connector of claim 13, wherein the cable assembly is one of a plurality of cable assemblies received in the cavity, the cable assemblies being independently movable relative to the connector housing.

17. The cable connector of claim 13, wherein the cable assembly actuators extend to an exterior of the connector housing to interface directly with the mounting bracket to move the cable assembly in the mating direction.

18. The cable connector of claim 13, wherein the housing walls include locating slots extending generally perpendicular to the circuit board, the cable assembly actuators received in the locating slots and movable in the locating slots in the mating direction generally perpendicular to the circuit board.

19. The cable connector of claim 13, wherein the cable assembly actuators are spring biased relative to the connector housing to move the contact assemblies and the ground shields in the mating direction.

20. A cable assembly for a cable connector, the cable assembly comprising:
cables in a cable array, each cable including a pair of signal wires and a foil shield surrounding the signal wires;
contact assemblies terminated to ends of the cables, each contact assembly including a contact holder holding signal contacts, the signal contacts including terminating ends terminated to ends of the signal wires and mating ends opposite the terminating ends, the mating ends having separable mating interfaces configured to interface with circuit conductors of a circuit board;
ground shields associated with the contact assemblies, the ground shields providing electrical shielding for the signal contacts, the ground shields including ground beams having separable mating interfaces configured to interface with ground pads of the circuit board; and
a cable assembly support including a support plate, the contact assemblies being coupled to the support plate, the ground shields being coupled to the support plate, the support plate including cable assembly actuators configured to be spring biased relative to a connector housing to move the contact assemblies and the ground shields in a mating direction relative to the connector housing.
